(19) United States
(12) Patent Application Publication
(10) Pub. No.: US 2026/0111553 A1
(43) Pub. Date: Apr. 23, 2026

(54) PRECONFIGURED INSTALLER FOR UNMANAGED DEVICES

(71) Applicant: Palo Alto Networks, Inc., Santa Clara, CA (US)

(72) Inventors: Eran Rom, Tel Aviv (IL); Meitar Naveh, Tel Aviv (IL)

(21) Appl. No.: 18/922,806

(22) Filed: Oct. 22, 2024

(51) Int. Cl. G06F 21/57; G06F 9/445; G06F 16/955

(52) U.S. Cl. CPC G06F 21/572; G06F 9/44505; G06F 16/955

(57) ABSTRACT

An installation service has been created to facilitate secure installation of software on unmanaged devices. An organization will set up, with the service, an application to be installed on devices of users of the organization, each with a configuration specified by the administrator. The service associates each pairing of installer and configuration with a random or pseudo-random identifier. When the service receives a request with an identifier, the service will retrieve the installer assigned the identifier, embed an identifier of the configuration into the installer without invalidating authenticity of the installer, and deliver it to the requestor. After the installer is validated and run on a device, the installer will detect the configuration identifier, authenticate the configuration identifier, and request the configuration data from the service. In response, the service provides the configuration data, digitally signed, to the installer.

### BACKGROUND

The disclosure generally relates to secure application installation and configuration of unmanaged devices (e.g., CPC subclass H04L 63 and CPC subclass G06F 21).

A security trust policy is typically defined for a device and includes authentication of an installer of a program/application. This relies on software publishers digitally signing their installers, also referred to as code signing. Code signing typically uses a certificate assigned to the software publisher from a certificate authority. Before the installer is executed, the device's operating system authenticates the installer based on the digital signature according to the security trust policy that governs the device. Authentication of the installer facilitates security of a device and can affect the integrity/reputation of a software developer.

### BRIEF DESCRIPTION OF THE DRAWINGS

Embodiments of the disclosure may be better understood by referencing the accompanying drawings.

FIG. 1 is a diagram illustrating seamless and secure application installation and configuration by the installation and configuration service by uniform resource locator (URL) distribution.

FIG. 2 is a diagram illustrating seamless and secure application installation and configuration by the installation and configuration service integrated into a login process.

FIG. 3 is a flowchart of example operations for setting up an application for seamless and secure installation and configuration by a service that is remote from unmanaged devices.

FIG. 4 is a flowchart of example operations for application installation and configuration via URL on unmanaged devices.

FIG. 5 depicts an example computer system with a URL-based application installation and configuration service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

While device management solutions allow organizations to enroll and then control devices to secure the organizations'data and systems, unmanaged devices are commonly introduced into organization networks and used to access an organization's assets. To fulfill at least some security goals, such as zero trust security, an installation and configuration service has been created to facilitate secure installation of software on unmanaged devices. In addition to secure installation, the installation securely and efficiently facilitates configuration of the software/application being installed. With the service, a user can seamlessly install and launch an application already configured in compliance with an organization's policies. An organization (e.g., an administrator of the organization) will set up, with the service, one or more installers to be installed on devices of users of the organization, each with a configuration or configuration data specified by the administrator. The service associates each pairing of installer and configuration data with a random or pseudo-random identifier. When the service receives a request with an identifier, the service will retrieve the installer associated with/assigned to the identifier, embed an identifier of the configuration data into the installer without invalidating authenticity of the installer, and deliver it to the requestor. Since the embedded configuration identifier is out of scope of the installer authentication, the service digitally signs the configuration identifier on behalf of the organization and preserves security of the installer, at least with respect to the embedded identifier. After the installer is validated and run on a device, the installer will detect the configuration identifier, authenticate the configuration identifier, and then request the configuration data from the service. In response, the service provides the configuration data, digitally signed, to the installer. After validating the configuration data, the installer configures the software being installed accordingly and the software launches as configured. The service provides this without requiring any more of a user than logging in to an organization and/or selecting a hyperlink that was provided to the user.

### Example Illustrations

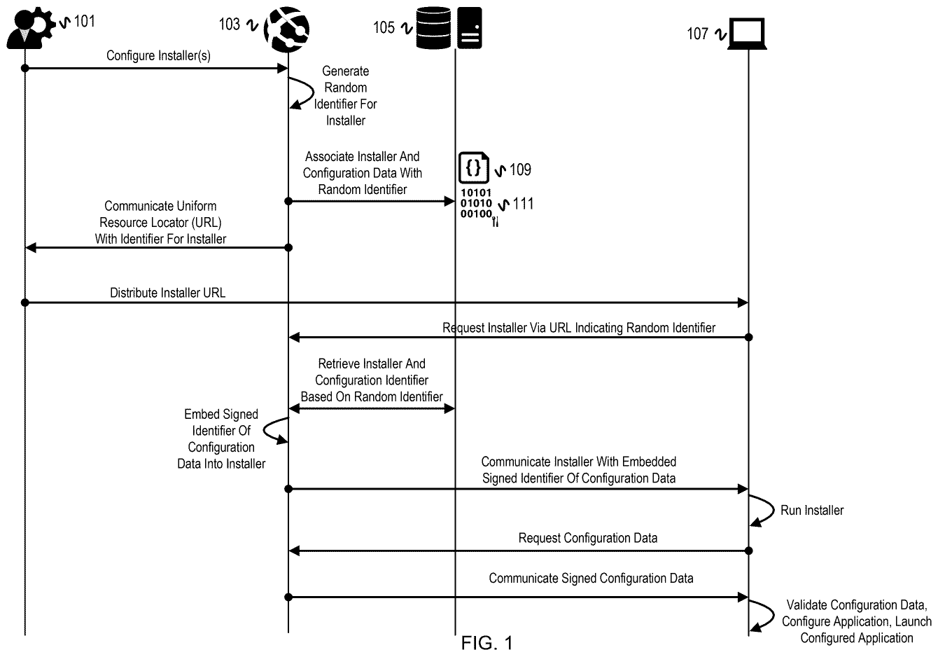

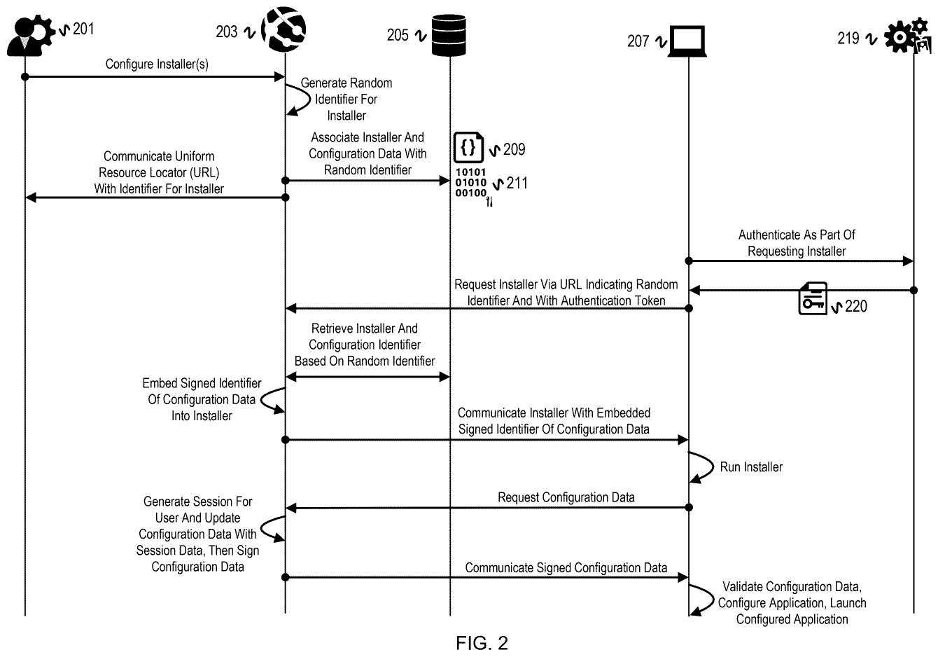

FIGS. 1-2 are diagrams that illustrate different initiation of secure application installation and configuration on an unmanaged device from a service (“installation and configuration service”). FIG. 1 is a diagram illustrating seamless and secure application installation and configuration by the installation and configuration service by URL distribution. The diagram depicts an administrator 101, a service 103, a backend 105, and an unmanaged device 107.

Initially, the administrator 101 will interact with the service 103 to set up an application for secure and seamless installation to unmanaged devices. The administrator 101 configures one or more installers with one or more requests to the service 103. For instance, the administrator 101 selects applications to install in a user interface presented by the service 103 from a catalog of applications available to a tenant corresponding to the administrator. The administrator 101 will indicate configurations or set configuration data to be applied to a selected application when installed. For each application with indicated configuration data, the service 103 generates a random (or pseudo-random) identifier and in the backend 105 associates/assigns the identifier (“installation identifier”) to the pairing of the application installer and the configuration data to be applied when the application is installed. In FIG. 1, the service 103 is depicted as associating an installation identifier to a pairing of an installer 109 and configuration data 111. The service 103 then communicates a URL of the service with the installation identifier for the installer 109 and configuration data 111 to the administrator 101.

To facilitate application installation and configuration across unmanaged devices of users associated with an organization, the administrator 101 distributes the URL with the installation identifier to unmanaged devices, including the unmanaged device 107. FIG. 1 depicts the unmanaged device 107 as a laptop for simplicity. The unmanaged devices can be any of the variety of devices that are bring your own device (BYOD). As examples, the administrator 101 can distribute the URL with the installation identifier as a hyperlink via electronic mail, text message, chat message, etc.

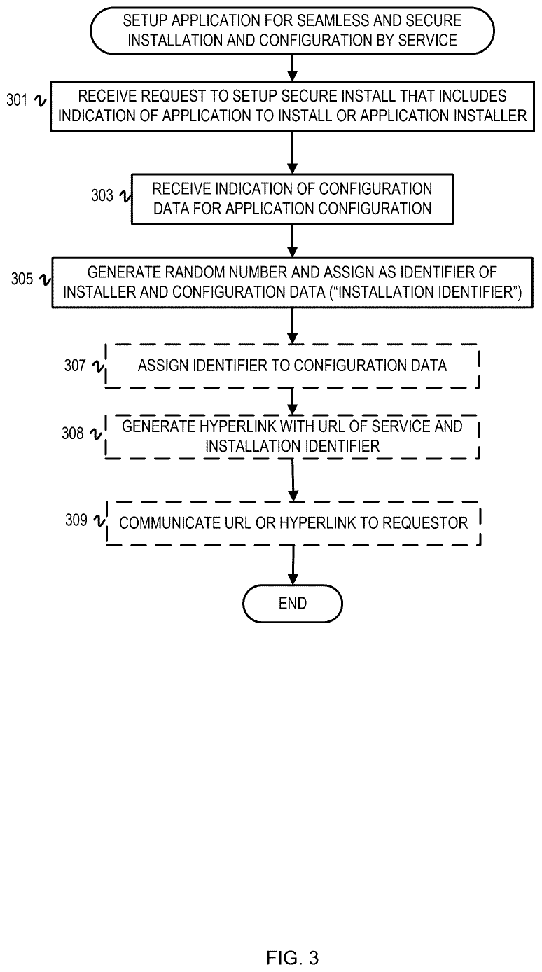

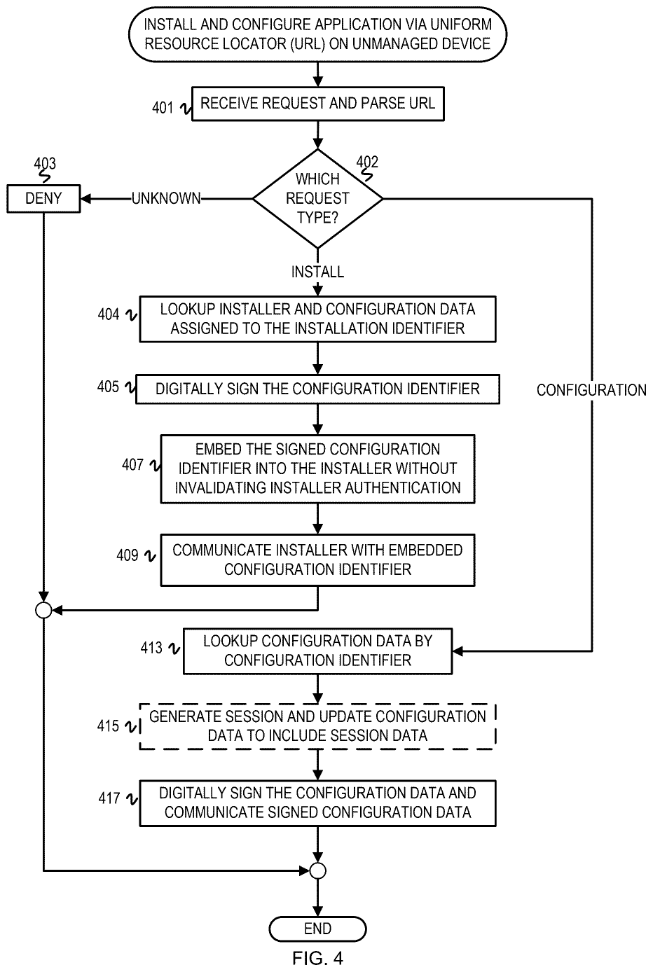

After receipt of the hyperlink, a user at the unmanaged device 107 selects the hyperlink which generates a request for the installer 109 to the service 103. The service 103 retrieves the installer 109 from the backend 105 and an identifier of the configuration data 111 based on the installation identifier. Determination of the configuration data identifier can vary by implementation and will be explored with reference to FIG. 3. The service 103 digitally signs the configuration data identifier and then injects or embeds the signed configuration data identifier into the installer 109 without “breaking” or invaliding a signature of the installer 109. It is presumed that any installer provided from the service 103 has been signed by the publisher of the application since the service 103 is providing trustworthy application installation and configuration. Embedding of the configuration data identifier will be discussed with reference to FIG. 4.

The service 103 communicates the installer 109 with the embedded signed configuration data identifier to the unmanaged device 107 for installation to commence. The unmanaged device 107 (hereinafter sometimes “device”) runs the installer 109, after authentication of the installer 109. During execution, the installer 109 reads configuration settings to determine configuration data to apply to the application being installed. The installer 109 (i.e., the process instantiated from execution of the installer 109) detects the configuration data identifier and requests of the service 103 configuration data identified by the configuration data identifier. The service 103 retrieves the configuration data 111 based on the configuration data identifier and signs the configuration data 111. The service 103 communicates the signed configuration data 111 to the device 107. The installer 109 validates/authenticates the signed configuration data and applies the configuration data 111 to configure the application. The installer 109 can then launch the application already configured without the user doing anything more than initially selecting the hyperlink.

FIG. 2 is a diagram illustrating seamless and secure application installation and configuration by the installation and configuration service integrated into a login process. The diagram depicts an administrator 201, an installation and configuration service 203, a backend 205, an unmanaged device 207, and an identity provider (IdP) service 209. Some of the operations of FIG. 2 in common with FIG. 1 are repeated, but with brevity.

As in FIG. 1, an administrator will set up the application installation and configuration for one or more applications with the service 203. In FIG. 2, the administrator 201 interacts with the service 203 to set up and configure one or more installers. The administrator 201 indicates configuration data 211 to be applied by an installer 209 when run. The service 203 generates a random installation identifier and associates/assigns the installation identifier to the pairing of the installer 209 and the configuration data 211. The service 103 then communicates a URL of the service 203 with the installation identifier for the installer 209 and configuration data 211 to the administrator 201. The administrator 201 configures a landing page or application installation page to collect attributes (e.g., application name and operating system or platform) and associates the installation service URL with the corresponding application name.

When a user at the unmanaged device 207 is presented the landing page or application installation page, the user is redirected to the IdP service 219 for authentication. After authentication, the IdP service 219 returns an authentication token 220. The authenticated user selects the relevant attributes for the application installation and configuration and selects the associated hyperlink. For example, the user selects a “submit” button that causes a browser to generate a hypertext transform protocol (HTTP) request to the service 203 via the installation service URL and includes the obtained authentication token 220. Query parameters of the URL will indicate the selected attributes and the random installation identifier.

After receipt of the HTTP request, the service 203 authenticates based on the authentication token 220 and then (assuming successful authentication) retrieves the installer 209 and an identifier of the configuration data 211 based on the installation identifier. The service 203 digitally signs the configuration data identifier and then embeds the signed configuration data identifier into the installer 209 without invaliding a signature of the installer 209.

The service 203 communicates the installer 209 with the embedded signed configuration data identifier to the device 207 for installation. The device 207 runs the installer 209, after authentication of the installer 209. During execution, the installer reads configuration settings to determine configuration data to apply to the application being installed. The installer 209 (i.e., the process instantiated from execution of the installer 209) detects the configuration data identifier and requests from the service 203 the configuration data identified by the configuration data identifier. The service 203 generates a session for the application being installed to interact with the backend 205 (or another backend that supports the application). The service 203 retrieves the configuration data 211 based on the configuration data identifier, updates the configuration data with the session data (e.g., session identifier and session secret), and signs the configuration data 211. The service 203 communicates the signed configuration data 211 (with the session data) to the unmanaged device 207. The installer 209 validates/authenticates the signed configuration data and applies the configuration data 211 to configure the application. The installer 209 can then launch the application already configured and with an active session already established without the user doing anything more than initially selecting the hyperlink.

While FIGS. 1 and 2 provided example illustrations for particular delivery initiation scenarios, FIGS. 3 and 4 are less case specific. FIGS. 3 and 4 depict flowcharts of operations. If a block of operation(s) is depicted with a dashed line, the dashed line indicates that the operation(s) are optional. The example operations are described with reference to a service (i.e., the application installation and configuration service) for consistency with the earlier figures and ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for setting up an application for seamless and secure installation and configuration by a service that is remote from unmanaged devices. The example operations can be repeated for each application to be set up for an organization or tenant.

At block 301, the service receives a request to set up secure install and configuration for an application. The request includes indication of an application to install or application installer. A request delivered, for instance as a HTTP request, identifies an application to install or an installer of the application. As noted in FIG. 1, this could be selection from a catalog of applications.

At block 303, the service receives an indication of configuration data for application configuration. Again, assuming a web-based service, the service receives an HTTP message that carries one or more configurations that have been selected and/or provided. For example, the configuration data may at least partially be selected from available configuration options for the application to be installed (e.g., selection of a border color for the application and language). In addition to selection or instead of selection, configuration data can be uploaded to the service. Other examples of the configuration data that can be specified and associated with an installer include an icon for white labeling, backend access (e.g., jurisdiction/country dependent access of a backend due to various data protection/privacy laws), reporting levels for issues, and installation location/path on the target device. In addition, configuration data can correspond to different user context based permissions. The indication of configuration data can also include attributes or user context to guide selection of a configuration.

At block 305, the service generates a random number as the installation identifier. Use of a random or pseudo-random value as an identifier allows the installation to be secure by reducing the likelihood of the service URL being misappropriated for a malicious purpose. The service assigns the installation identifier to the installer and configuration data. For instance, the service stores an entry in a backend of the service that associates the installer and the configuration data with the identifier as an index or tag. Instead of the installation identifier identifying the pairing of an installer and configuration data, the installation identifier can identify the installer and the installer can be associated with multiple configurations. A tenant or organization may have multiple configurations for a same application. For example, an enterprise may specify different configurations for different jurisdictions (e.g., different data privacy settings depending on jurisdiction) and different departments (e.g., different permissions depending on department). User attributes, such as department and/or country, can determine which configuration to use. Attributes of a user can be collected, for example at login, to drive configuration selection.

At block 307, the service assigns an identifier to the configuration data. This presumes an implementation in which the installation identifier is not being used to identify both the installer and the configuration data. The service can generate another random identifier for the configuration data or generate a hash of the configuration data to be used as a configuration data identifier. The service can use a counter as an identifier for data of each configuration. Alternatively, the service can assign a unform resource identifier (URI) to each configuration.

At block 308, the service generates a hyperlink with the URL of the service and the installation identifier as a parameter in the URL. The service can set an expiration for the hyperlink for security reasons.

At block 309, the service communicates the URL or the hyperlink with the installation identifier to the requestor. The service can communicate a hyperlink to the requestor, which can then be distributed or used in a webpage. Alternatively, the service can communicate the URL in a message and the URL can be used to configure a redirect (e.g., in a IdP setting) or set as a reference in a webpage. In some cases, the service can be created or configured to interface with another service, such as the IdP service, to set the URL for redirects after authentication.

FIG. 4 is a flowchart of example operations for application installation and configuration via a URL on unmanaged devices. The example operations of FIG. 4 are the operations performed by the application installation and configuration service after the setup described in FIG. 3 and are agnostic with respect to how the URL/hyperlink was provided.

At block 401, the service receives a request that includes a URL, such as a HTTP request. The service parses the URL to determine what is being requested. The URL likely includes a query parameter or subdomain that allows the service to disambiguate a request for an installer, a request for configuration data, or an unknown request. For example, an installation request URL may be www. install_example. com/12345699 and a configuration data request URL may be “www. configure. install_example. com/5577”.

At block 402, the service determines the type of request after parsing the URL in the request. If the request is an installation request, then operational flow proceeds to block 404. If the service is a configuration data request, then operational flow proceeds to block 413. Otherwise, the request is of unknown type and the request is denied at block 403.

At block 404, the service looks up the installer and configuration associated with or assigned to the installation identifier. An installation request will have included an installation identifier. After determining the request was an installation request, the service continues parsing the URL and extracts the installation identifier from the URL. The service queries the backend (e.g., a storage service or database) with the installation identifier to access an entry that indicates the installer and the configuration data.

At block 405, the service digitally signs an identifier of the configuration. Assuming the installation identifier does not identify one configuration or the installer is associated with multiple configurations, the service may determine a configuration based on other attributes or parameters indicated in the request as previously discussed. Whether the installation identifier is used or another identifier is used to identify a configuration, the service digitally signs the configuration identifier. The service may sign using a certificate assigned to a tenant or assigned to the service.

At block 407, the service embeds the signed configuration identifier into the installer without invalidating installer authentication. The service uses an identifier instead of embedding the configuration data because the area that will be used is likely a small space that cannot accommodate the configuration data. The service embeds the signed configuration identifier into a path or field of the installer that is not included within the digital signature. For instance, the Authenticode code signing technology signs binary of the installer but does not hash or sign some areas. Thus, the service can embed the signed configuration identifier into a portable executable (PE) or binary section that will not invalidate the signature of the binary/PE (e.g., in unauthenticated attributes in space after a signature/formatted signature data, in a dummy certificate, etc.). For an example that refers to a disk image, an application install bundle within the image can include an installer that is designed/programmed to search a specified path of the installer for the configuration identifier and to retrieve a configuration corresponding to the configuration identifier. While the space that can be used but does not invalidate a code signature is likely small (e.g., less than 200 bytes), the space is sufficient to embed a signed identifier. And security can be preserved since the configuration identifier is signed, which will allow validation by the installer when run. As another example, a code signing technology may not sign a preconfigured path of the installer, such as a resource path in an installer. The service can embed the signed configuration identifier in this path. Embedding the signed configuration identifier into the installer presumes that the installer is programmed to read this area and submit to the service a request for a configuration identified by the configuration identifier. In some cases, the service embeds a URL with a service identifier for configuration retrieval and the configuration identifier if the installer is not programmed or configured to interact with the service to retrieve the configuration data.

At block 409, the service communicates the installer with the embedded configuration identifier to the requestor. Operational flow ends after block 409.

If the received request is a configuration request from an installer, then the service looks up configuration data by the configuration identifier at block 413. After determining that the request is a configuration request, the service continues parsing the URL in the request and to extract a configuration identifier.

At block 415, the service generates a session and updates configuration data to include the session data. When the application installation and configuration was initially set up, a value would have been set indicating whether a session should be created for a user as part of application configuration. Indication of whether a session should be created may be indicated in the configuration data read by the service or may be set as a flag or other value in the entry corresponding to the installer and configuration.

At block 417, the service digitally signs the configuration data and communicates the signed configuration data to the requestor. The service signs the configuration data to maintain integrity of the installation and configuration process. Operational flow ends after block 417.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

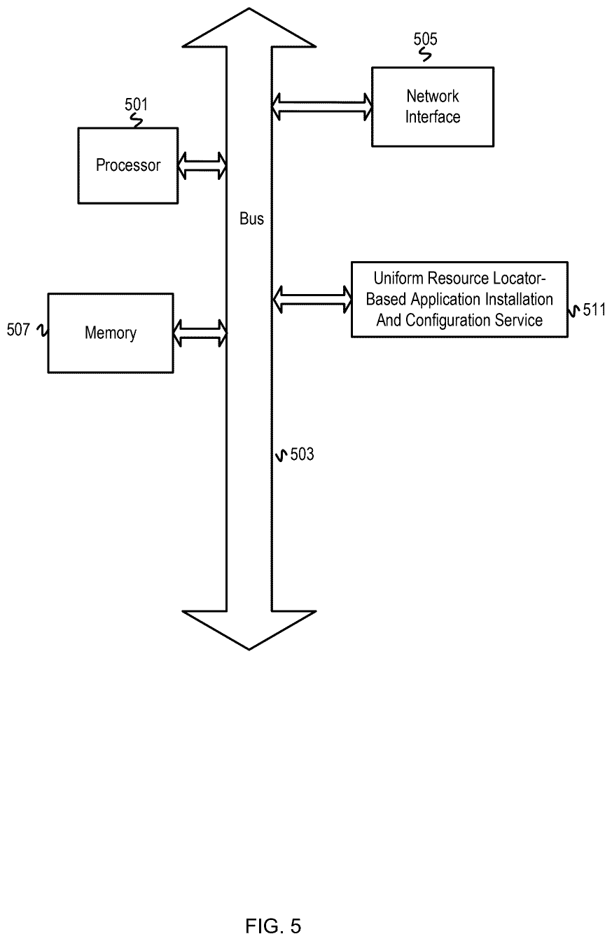

FIG. 5 depicts an example computer system with a URL-based application installation and configuration service. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes URL-based application installation and configuration service (service) 511. After an application has been set up for installation and configuration with the service 511, the service 511 uses a random number generator to generate a random identifier and assigns the random identifier to the application installer. The service 511 also associates the installer with one or more configurations specified for the installer. The service 511 encodes the identifier into a URL with a domain for the service and provides the URL for accessing the installer. When the service 511 receives a request with the URL, it injects or embeds a signed identifier of a relevant configuration into the installer without compromising a signature applied to the installer. After the installer is run and detects the configuration identifier in a path that the installer reads, the installer authenticates the configuration identifier and then uses the configuration identifier to request the relevant configuration data from the service 511. In response, the service 511 retrieves the configuration data associated with the configuration identifier, signs the configuration data, and returns the configuration data to the installer. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
assigning a randomly generated identifier to each of a set of one or more signed installers;
based on receipt of a first request that includes a first uniform resource locator (URL) for a service and a first identifier,
retrieving a first of the set of signed installers assigned a first of the randomly generated identifiers that matches the first identifier;
determining first configuration data for the first signed installer and an indicator of the first configuration data;
embedding a validation identifier corresponding to the first configuration data indicator into the first signed installer;
communicating to a requestor of the first request the first signed installer; and
based on receipt of a second request that indicates the first configuration data indicator,
retrieving the first configuration data; and
communicating to the requestor the first configuration data and corresponding authentication data for the first configuration data.

2. The method of claim 1, wherein retrieving the first signed installer comprises searching among the randomly generated identifiers for the first identifier.

3. The method of claim 1 further comprising:
in response to an installer configuration request,
the service assigning, in a backend associated with the service, the first configuration data indicator to the first configuration data and associating the first configuration data with the first signed installer; and
communicating the first URL indicating the first signed installer and the first randomly generated identifier,
wherein assigning the one or more randomly generated identifiers is by the service.

4. The method of claim 1, wherein embedding the indicator of the first configuration data comprises embedding the indicator into an area of the first signed installer that does not invalidate the first signed installer or into a path attribute of the first signed installer.

5. The method of claim 1 further comprising setting an expiration time for the first URL.

6. The method of claim 1, wherein the first request also includes an authentication token issued by an identity provider.

7. The method of claim 6 further comprising:
the service, which is receiving the requests and responding to the requests,
creating a first session based on an authentication token in response to the second request, wherein the session is with a backend endpoint associated with the service; and
updating the first configuration data with information about the first session prior to communicating the first configuration data.

8. The method of claim 1 further comprising digitally signing the indicator of the first configuration data and the first configuration data.

9. The method of claim 1, wherein the indicator of the first configuration data is one of a URL, a uniform resource identifier (URI), executable code for retrieving the configuration data, and an identifier determined by the service receiving the first and second requests and responding to the requests.

10. The method of claim 1 further comprising the requestor validating the first signed installer, running the first signed installer after successful validation, and validating the indicator of the first configuration data, wherein the indicator was digitally signed prior to communication of the first signed installer and the second request is communicated after successful validation of the indicator of the configuration data.

11. The method of claim 1 further comprising the requestor validating the first configuration data based on the authentication data.

12. A non-transitory, machine-readable medium having stored thereon program code, the program code comprising instructions to:
assign a random identifier to each of a set of one or more signed installers;
based on receipt of a first request that includes a first uniform resource locator (URL) for a service and a first identifier,
retrieve a first of the set of signed installers assigned a first of the randomly generated identifiers that matches the first identifier;
determine first configuration data for the first signed installer and an indicator of the first configuration data;
embed a validation identifier corresponding to the first configuration data indicator into the first signed installer;
communicate to a requestor of the first request the first signed installer; and
based on receipt of a second request that indicates the first configuration data indicator,
retrieve the first configuration data; and
communicate to the requestor the first configuration data and corresponding authentication data for the first configuration data.

13. The non-transitory, machine-readable medium of claim 12, wherein the program code further comprises instructions to:
in response to an installer configuration request,
assign, in a backend associated with the service, the first configuration data indicator to the first configuration data and associate the first configuration data with the first signed installer; and
communicate the first URL indicating the first signed installer and the first randomly generated identifier.

14. The non-transitory, machine-readable medium of claim 12, wherein the instructions to embed the indicator of the first configuration data comprise instructions to embed the indicator into an area of the first signed installer that does not invalidate the first signed installer or into a path attribute of the first signed installer.

15. The non-transitory, machine-readable medium of claim 14, wherein the program code further comprises instructions to:
create a first session based on an authentication token in response to the second request, wherein the session is with a backend endpoint associated with the service, wherein the first request also includes the authentication token issued by an identity provider; and
update the first configuration data with information about the first session prior to communicating the first configuration data.

16. The non-transitory, machine-readable medium of claim 12, wherein the program code further comprises instructions to digitally sign the indicator of the first configuration data and the first configuration data.

17. An apparatus comprising:
a processor; and
a machine-readable medium having instructions stored thereon executable by the processor to cause the apparatus to,
assign a randomly generated identifier to each of a set of one or more signed installers;
based on receipt of a first request that includes a first uniform resource locator (URL) for a service and a first identifier,
retrieve a first of the set of signed installers assigned a first of the randomly generated identifiers that matches the first identifier;
determine first configuration data for the first signed installer and an indicator of the first configuration data;
embed a validation identifier corresponding to the first configuration data indicator into the first signed installer;
communicate to a requestor of the first request the first signed installer; and
based on receipt of a second request that indicates the first configuration data indicator,
retrieve the first configuration data; and
communicate to the requestor the first configuration data and corresponding authentication data for the first configuration data.

18. The apparatus of claim 17, wherein the machine-readable medium further has stored thereon instructions executable by the processor to cause the apparatus to:
in response to an installer configuration request,
assign, in a backend associated with the service, the first configuration data indicator to the first configuration data and associate the first configuration data with the first signed installer; and
communicate the first URL indicating the first signed installer and the first randomly generated identifier.

19. The apparatus of claim 17, wherein the instructions to embed the indicator of the first configuration data comprise instructions executable by the processor to cause the apparatus to embed the indicator into an area of the first signed installer that does not invalidate the first signed installer or into a path attribute of the first signed installer.

20. The apparatus of claim 19, wherein the machine-readable medium further has stored thereon instructions executable by the processor to cause the apparatus to:
create a first session based on an authentication token in response to the second request, wherein the session is with a backend endpoint associated with the service, wherein the first request also includes the authentication token issued by an identity provider; and
update the first configuration data with information about the first session prior to communicating the first configuration data.

21. The apparatus of claim 17, wherein the machine-readable medium further has stored thereon instructions executable by the processor to cause the apparatus to digitally sign the indicator of the first configuration data and the first configuration data.
